(19) United States
(12) Patent Application Publication
(10) Pub. No.: US 2009/0242485 A1
(43) Pub. Date: Oct. 1, 2009

(54) PURIFIED WATER DISPENSING MACHINE

(76) Inventor: Rick H. Cabados, Encinitas, CA (US)

Correspondence Address: ERIC HANSCOM, 7395 PORTAGE WAY, CARLSBAD, CA, 92011, US

(21) Appl. No.: 12/481,855

(22) Filed: Jun. 10, 2009

Related U.S. Application Data
(63) Continuation-in-part of application No. 11/970,136, filed on Jan. 7, 2008.
(60) Provisional application No. 60/920,217, filed on Mar. 26, 2007.

(51) Int. Cl. C02F 1/44

(52) U.S. Cl. 210/652; 210/198.1; 210/101

(57) ABSTRACT

A unique water purification system for use in vending machine applications. The invention can be configured several different ways, with the goal of purifying the water through the reverse osmosis component, and optionally sanitizing it with UV light, then re-mineralizing the water, and finally optionally alkalizing and electrolyzing with an electric-based water ionizing machine. The result is water from which all impurities have been removed and disinfected by optional ultra violet treatment, but which also contains never before seen amounts of beneficial alkaline helpful minerals and/or powerful anti-oxidants. Without adding the minerals, the machine would not ionize and alkalize the water as efficiently. This unique combination of reverse osmosis, with optional UV, will create very pure water that can then have liquid or granular minerals added, and be alkalized and ionized to make it very healthy for human consumption.

### CROSS REFERENCE TO RELATED APPLICATIONS

This application is a continuation-in-part of U.S. patent application Ser. No. 11/970,136 filed on Jan. 7, 2008, which in turn is a non-provisional of U.S. Provisional Patent Application No. 60/920,217 filed on Mar. 26, 2007, the entireties of which are hereby incorporated by reference.

### STATEMENT REGARDING FEDERALLY SPONSORED RESEARCH OR DEVELOPMENT

This invention was not federally sponsored.

### BACKGROUND OF THE INVENTION

This invention is directed toward a unique water purification system for use in vending machine applications. The invention can be configured several different ways, with the goal of purifying the water through the reverse osmosis component, and optionally sanitizing it with UV light, then re-mineralizing the water, and finally optionally alkalizing and electrolyzing with an electric-based water ionizing machine. The result is water from which most if not all impurities have been removed and disinfected by optional ultra violet treatment, but which also contains never before seen amounts of beneficial alkaline helpful minerals and/or powerful anti-oxidants. Without adding the minerals, the machine would not ionize and alkalize the water as efficiently. This unique combination of reverse osmosis, with optional UV, will create very pure water that can then have liquid or granular minerals added, and be alkalized and ionized to make it very healthy for human consumption.

It is desirable to produce water that has a pH of 7 or higher (a pH of 7 is neutral). It has been shown that a pH below 7 will cause corrosion in metal pipes carrying water. Additionally, the ideal pH of water for human consumption is generally considered to be in the range of 8 to 10, as acidic water has been determined to be the root cause of many diseases. Past reverse osmosis systems have produced slightly to severely acidic water, with a pH of between 4 and 6. To bring the pH up to 7, a form of calcium called Calcite can be added to the water to raise the pH. The invention also provides means by which the pH of water can be brought up dramatically higher for optimal health benefits. There are two basic devices that can accomplish this reaction. First, specially designed and produced ceramic beads, specifically designed to increase pH and add anti-oxidants to drinking water. Second, a system can inject liquid or infuse granular minerals and anti-oxidants into the water after it passes through the reverse osmosis portion of the invention but before the water exits the faucets. The re-mineralized and anti-oxidant rich water is then run through an optional electric based electrolysis system. This technology can be designed in small residential point of use systems, water dispensers/vending machines, animal rearing, horticulture, agriculture, and large commercial/industrial applications.

The desire for purified water has been present for many years. Early attempts at purifying water date back to 2,000 B.C. when early Sanskrit writings discussed methods of purifying water, including boiling, placing heated metal objects in the water prior to consumption, and filtering through basic sand and/or charcoal filters. Centuries later, Hippocrates performed his own water purification experiments using a cloth bag, later known as the Hippocrates sleeve, which would trap sediments from water and improve the taste and smell of the water.

In the Middle Ages, desalination experiments using sand filters were performed by Sir Francis Bacon and, although they failed, provided not only the basic equipment and theories, but also the inspiration for future generations of scientists and innovators. The next leap in technology came during the Renaissance with the advent of the microscope and the earlier reliance upon concave pieces of glass to magnify objects. Soon, it became obvious that a single drop of water contained a myriad of different types of plant and animal life, and intelligent minds concluded that not all these forms of life were beneficial to humans who consumed the water. In the mid-1800s, government officials in London began to connect the spread of deadly cholera with the poor quality of the drinking water. Upon installing sand filters between the source of drinking water and the end users, London city officials found that the incidence of cholera decreased significantly. The British scientist John Snow examined some water contaminated by a sewage leak and linked several cholera deaths to cholera bacteria

Snow's discovery led to a widespread increase in the use of sand filters, and was responsible for the beginnings of municipal water treatment. The French in particular, began to demand clean water as a “right” of citizenship. While most cities relied on the sand filters, problems with large-scale sand filters began to make themselves obvious. They required extensive cleaning, and became clogged frequently, requiring a substantial amount of time just to maintain their filtering capacity. The idea, however, of a municipal water treatment system, installed and maintained by governmental officials, had taken hold and was not to pass out of popularity.

The next major improvement was the use of chlorine to treat drinking water, a method that remains popular today, with nearly 99% of all municipal water treatment facilities using chlorine or chlorine combined with ammonia to sanitize their water. However, since chlorine is officially listed as a “poison,” finding other methods of purifying water was desirable. As governments have proven incapable of providing drinking water of a quality that many desire, the popularity of individual purification units to sell water to individual consumers has become more and more popular.

As technology progressed, reverse osmosis systems became popular whereby tap water was forced through a semi-permeable membrane that let through water molecules and strained out all other molecules. While it was beneficial to remove some “impurities”, such as microscopic viruses and bacteria, toxic metals, and other harmful components of untreated water, the reverse osmosis filters also removed the beneficial minerals that humans require for body maintenance and growth. Since many of these minerals are required in only trace amounts, drinking water containing these minerals is an easy way to consume the suggested minimum daily requirements. Thus, reverse osmosis machines performed both beneficial and harmful operations on drinking water.

Another method of treating water that has become popular over the past several years has been to ionize water. Water ionizing can be accomplished with specially designed ceramic beads and/or electrolysis machines to separate out high pH water from low pH water. Low pH, acidic water is generally considered good for cleaning and disinfecting, while high pH, alkaline water is desirable for drinking, as it more effectively creates anti-oxidant rich water to flush out acidic compounds in the body and micro clusters of water molecules which are absorbed more readily by the body and facilitate absorption of minerals and nutrients.

An additional treatment method for water is to apply ultraviolet radiation to untreated water. Ultraviolet radiation will kill most living organisms in water, such as bacteria and viruses; harmful living organisms are killed before they are drank with water.

Liquid or granular remineralizing filters are an additional treatment option for tap water. While some purification methods, such as reverse osmosis, remove all impurities from water, including good impurities like beneficial minerals, liquid or granular remineralization adds these good impurities back into the treated water.

The main problem facing consumers of purified water is that while all of the various treatment methods and machines modify tap water in some manner prior to its being consumed, none provide a clean water, free of debris and living organisms, with desirable amounts of minerals remaining in the water, where the water can be adjusted as to pH content as well as ionized. Thus there has existed a long-felt need for a system as provided by this invention.

The system in its theoretical state is a water purification system which uses some combination of water ionizers, sanitization devices, reverse osmosis filters, remineralizers, distillers, pH-modifying devices, and additives to provide purified water which is pleasant tasting, purified, fortified with beneficial minerals, and of a beneficial pH at or above 7. The invention can be configured several different ways, with the goal of purifying the water through the reverse osmosis component, and optionally sanitizing it with UV light, then remineralizing the water, and finally alkalizing and ionizing the water with optional electrolysis. The result is purified water from which all impurities have been removed, but which also contains helpful minerals. Without adding the minerals, the machine would not ionize and alkalize the water. This unique combination of reverse osmosis, with optional UV, will create very pure water that can then have minerals added, and be alkalized and ionized to make it very healthy for human consumption.

There are several different types of water dispensing/vending machines that are used in various commercial/industrial applications. For example, there are many commercial water vending machines, normally approximately six feet high and four feet wide, which produce “purified” water for consumer consumption. Many of these machines have mere filters or reverse osmosis only systems in between the source of regular tap water and the faucet from which the “purified” water is sold. The current invention provides a substantial improvement over such systems as the addition of small, compact optional electrolysis machines and remineralizers with, optionally, reverse osmosis units and distillers, which provide water that has not only been purified, but also contains beneficial minerals and comes out of the tap with higher pH. The commercial water machines have pumps built in to force the tap water through any existing purification or filtering devices and out the dispensing faucet. Thus, it would not require substantial effort or cost to splice the invention into the existing water line and allow the pre-existing pump to force the tap water through the invention before dispensing the purified water through the faucet.

A further improvement in the commercial vending machine is to add flavors to the water as it is released from the faucet. Flavored water is extremely popular, as evidenced by the large number of companies that sell water with various flavorings. Because the flavorings would be added after the last water modification unit in the series of such units between the source of water and the faucet, there is no need to store different types of water with different flavors.

The same design can also be incorporated to a smaller water dispenser. Many offices, waiting rooms, and even homes have small stands, usually three to four feet high, upon which a small water container (usually five gallons) can be placed upside down or that have a direct water feed. The water then flows, by gravity, out a faucet when a button is depressed. Most of these smaller units merely dispense the water which has been purchased; few modify the water in any way. Since mineralizers, ionizers, reverse osmosis units and distillers can all be made in very small and compact sizes and shapes, it is feasible to build these units into the body of one of these small stands.

The ionizer and other electronics of the system emit electromagnetic radiation. To reduce these emissions, the electrical section of the system can be surrounded with layers of metallic foil, preferably made from nickel, cobalt, iron, or tin. At least nine layers of metallic foil are preferably used to significantly reduce the amount of electromagnetic radiation emitted from the system.

### SUMMARY OF THE INVENTION

It is a principal object of the invention to provide one apparatus that can filter, ionize, mineralize, optionally electrolyze, and, optionally, flavor water for human consumption.

It is another object of the invention to provide one machine capable of all of these various operations that is less costly and takes up less space than purchasing one of each of the machines currently on the market, which are capable of performing one of these functions.

A further object of this invention is to provide a single unit which can be spliced into the existing water supply to a fixed structure, or structures, to provide a variety of water filtration, purification, and remineralization functions within a conveniently sized and shaped container.

Additional objects of the invention include providing a small, compact unit that can be spliced or manufactured into the water supply running through a commercial water vending machine.

Another object of the invention is to provide a small, compact unit that can be spliced, or manufactured, into the existing water supply of a small, portable water dispensing machine.

It is a final object of this invention that the base unit offers the user several flexible options, including UV treatment, distillation, and other treatment methods which can be included in the base unit or added to it with minimal inconvenience.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

FIG. 1 is a diagram of a combination of a reverse osmosis filter, and a remineralizer to create the final water product.

FIG. 2 is a diagram of a combination of a reverse osmosis filter, a remineralizer, and an ionizer to create the final water product.

FIG. 3 is a diagram of a combination of a reverse osmosis filter, an ultraviolet purifier, a remineralizer, and an ionizer to create the final water product.

FIG. 4 is a diagram of a combination of a reverse osmosis filter, a distiller, a remineralizer, and an ionizer to create the final water product.

FIG. 5 is a diagram of a combination of tap water, a distiller, a remineralizer, and an ionizer to create the final water product.

FIG. 6 is a diagram of a combination of tap water, a distiller, and a remineralizer to create the final water product.

FIG. 7 is a diagram of a combination of tap water, a distiller, a remineralizer, an ionizer, a flavoring system, a heater, and a cooler to create the final water product.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

The invention is a combination of elements into one shielding compartment. While there are a number of difference sizes and configurations possible for the shielding compartment, a preferred embodiment of the invention is a unit with stainless steel or a similarly fashionable and durable exterior, plenty of room in the interior for the various components, and one or more nozzles from which the purified, remineralized and optionally electrolyzed water is emitted. The face of the compartment can house a wide variety of dials and gauges, depending on how much control the user is given over the eventual product. The size of the unit depends upon the intended audience. For example, a commercial unit intended to be placed in front of a supermarket may measure six feet high and have spring-loaded vending chamber doors to keep the area in which water purchasers place their containers free from dust. The power supply needed to operate such a machine is also dependant upon its size, and the use of emergency battery backup systems is contemplated by the inventor.

Because of the inventor's selection of the elements, there are a number of different orders in which the individual elements can appear in a line between tap water and the final product. Several of the preferred embodiments of the invention are laid out below:

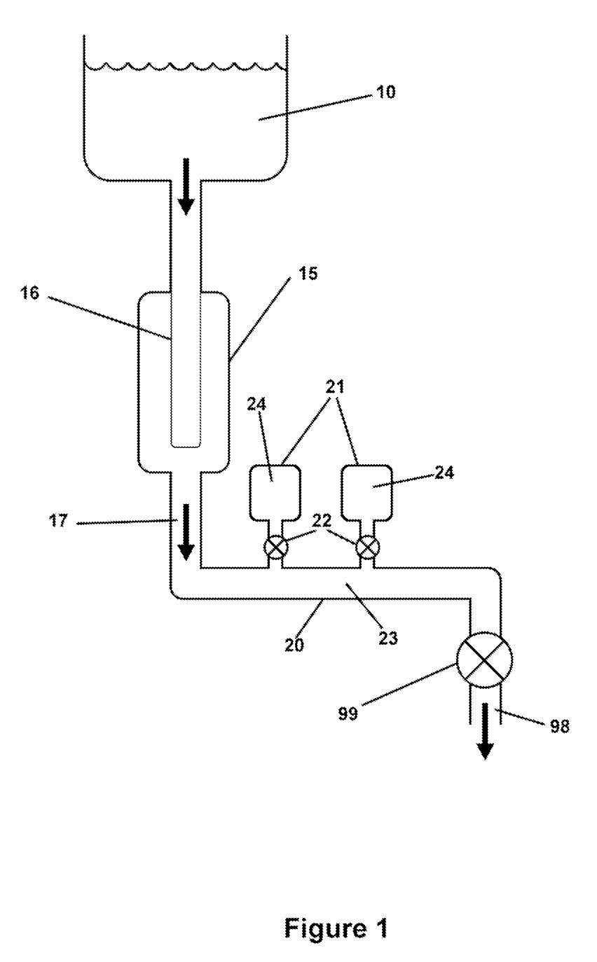

FIG. 1 is a machine with a combination of a reverse osmosis filter, and a remineralizer to create the final water product. Tap water 10 flows into a reverse osmosis filter 15. In the reverse osmosis filter 15, the tap water 10 passes through a thin membrane 16, which removes impurities. Water that exits the reverse osmosis filter 17 travels to a remineralizer 20. In this embodiment, the remineralizer 20 has minerals 24 located in containers 21. Regulating devices 22 regulate the amount of minerals 24 that are added to water in the remineralizer 23. The water that exits the remineralizer 20 is the final water product 98 that exits the device through a valve 99, which regulates the flow of final water product 98 from the base unit.

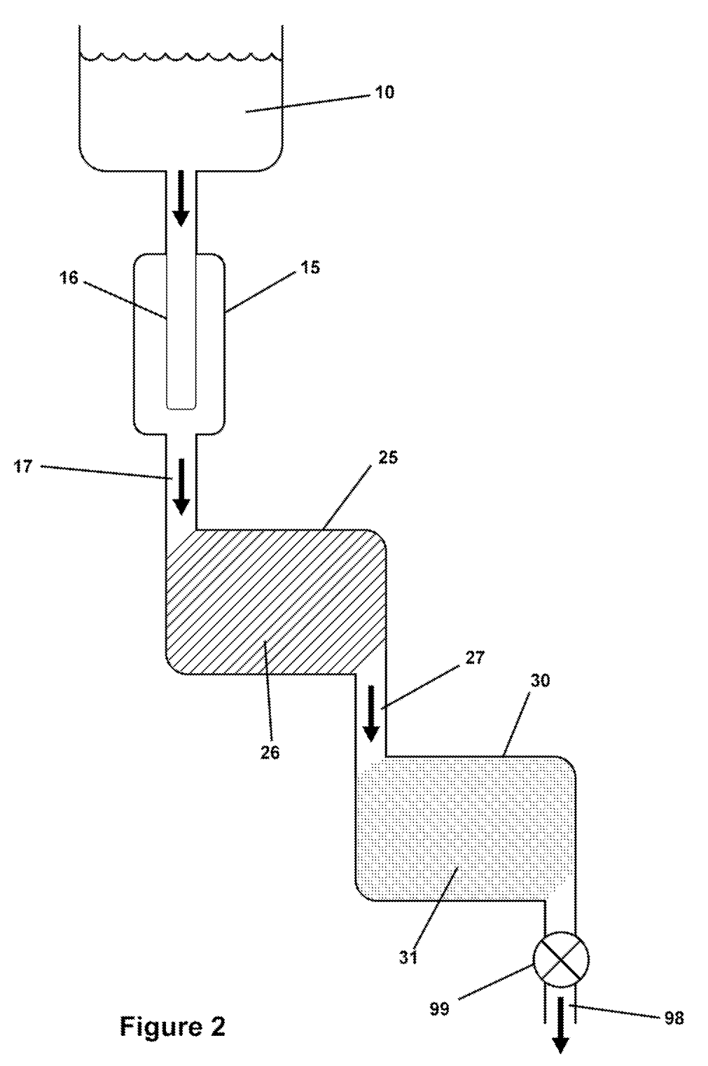

FIG. 2 is a machine with a combination of a reverse osmosis filter, a remineralizer, and an ionizer to create the final water product. Tap water 10 flows into a reverse osmosis filter 15. In the reverse osmosis filter 15, the tap water 10 passes through a thin membrane 16, which removes impurities. Water that exits the reverse osmosis filter 17 travels to a remineralizer 25. In this embodiment, the water from the reverse osmosis filter 17 travels through the remineralizer 25, which contains minerals 26. The water that exits the remineralizer 27 now contains minerals that it would not have had had the water that exits the reverse osmosis filter 17 not passed through the remineralizer 25. The water that exits the remineralizer 27 then travels to a holding tank, and then from the holding tank to an ionizer 30, where the ionizer 30 raises the pH of water. In this embodiment, water that passes through the ionizer 30 travels through ceramic beads 31 that raise the pH of the water. The water that exits the ionizer 32 has a higher pH than it would have had had the water that exits the remineralizer 27 not passed through the ionizer 30. The final water product 98 then exits the device through a valve 99, which regulates the flow of final water product 98 from the device.

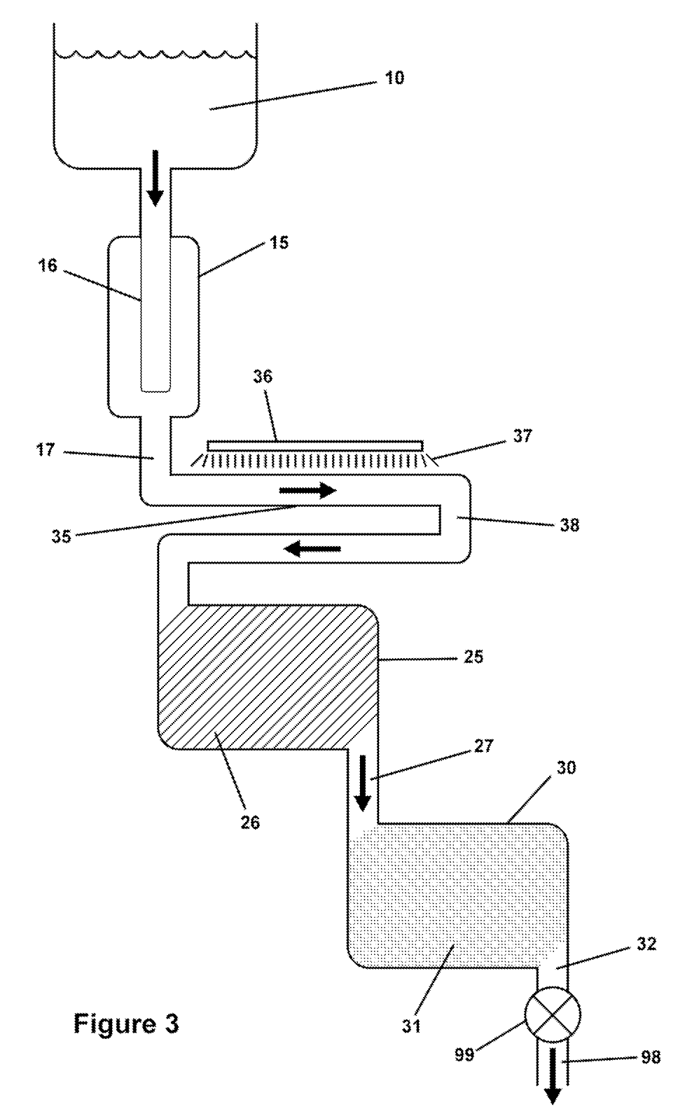

FIG. 3 is a machine with a combination of a reverse osmosis filter, an ultraviolet purifier, a remineralizer, and an ionizer to create the final water product. Tap water 10 flows into a reverse osmosis filter 15. In the reverse osmosis filter 15, the tap water 10 passes through a thin membrane 16, which removes impurities. Water that exits the reverse osmosis filter 17 travels to an ultraviolet purifier 35. The ultraviolet purifier 35 acts as a sanitation device and uses ultraviolet radiation 37 to purify water. A source for ultraviolet light 36 emits ultraviolet radiation 37 to purify the water that exits the reverse osmosis filter 17. The water that leaves the ultraviolet purifier 38 has lower levels of harmful bacteria and viruses than it would have had had the water that exits the reverse osmosis filter 17 not traveled through the ultraviolet purifier 35. The water that exits the ultraviolet purifier 38 then travels to a remineralizer 25. In this embodiment, the water from the reverse osmosis filter 17 travels through the remineralizer 25, which contains minerals 26. The water that exits the remineralizer 27 now contains minerals that it would not have had had the water that exits the ultraviolet purifier 38 not passed through the remineralizer 25 The water that exits the remineralizer 27 then travels to a holding tank, and then from the holding tank to an ionizer 30, where the ionizer 30 raises the pH of water. In this embodiment, water that passes through the ionizer 30 travels through ceramic beads 31 that raise the pH of the water. The water that exits the ionizer 32 has a higher pH than it would have had the water from the remineralizer 27 not passed through the ionizer 30. The final water product 98 then exits the device through a valve 99, which regulates the flow of final water product 98 from the device.

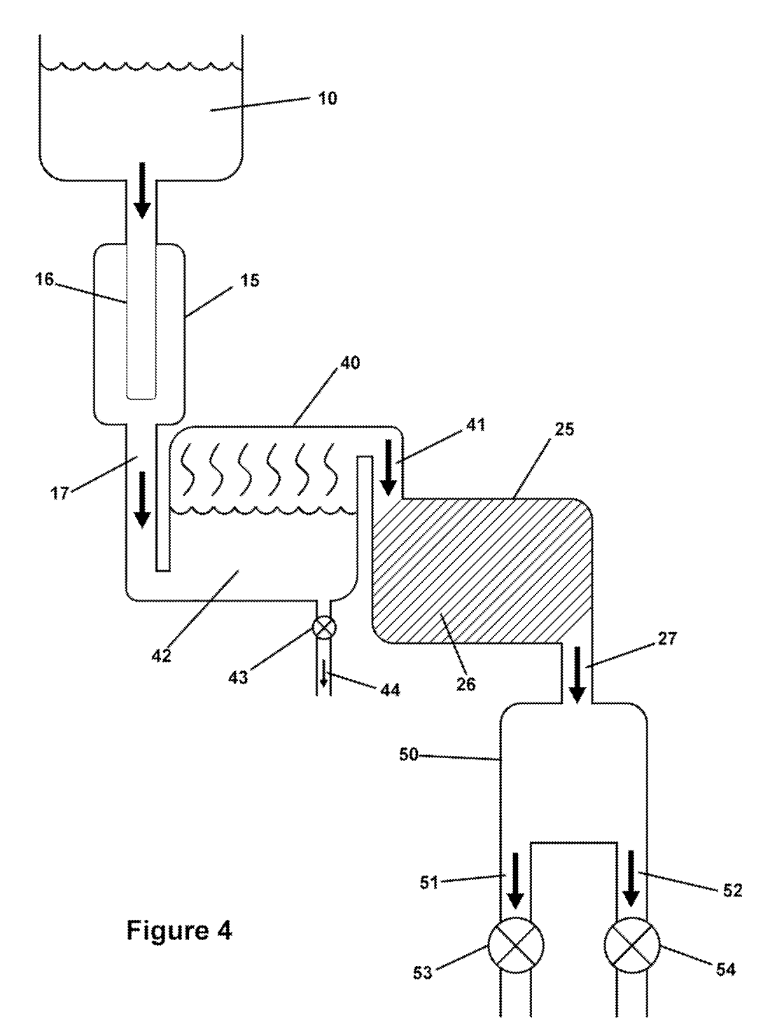

FIG. 4 is a machine with a combination of a reverse osmosis filter, a distiller, a remineralizer, and an ionizer to create the final water product. Tap water 10 flows into a reverse osmosis filter 15. In the reverse osmosis filter 15, the tap water 10 passes through a thin membrane 16, which removes impurities. Water that exits the reverse osmosis filter 17 travels to a distiller 40. The water in the distiller 42 is heated, and purified water leaves the distiller 40. The distiller can have an optional valve 43 where wastewater 44 can be drained from the distiller 40. The water that exits the distiller 41 travels to a remineralizer 25. In this embodiment, the water from the reverse osmosis filter 17 travels through the remineralizer 25, which contains minerals 26. The water that exits the remineralizer 27 now contains minerals that it would not have had had the water that exits the distiller 41 not passed through the remineralizer 25. The water that exits the remineralizer 27 then travels to a holding tank, and then from the holding tank to an ionizer 30, where the ionizer 30 raises the pH of water. In this embodiment, electrolysis can be used in the ionizer 50 to separate the water into low pH water 51 and high pH water 52. A low pH valve 53 is used to regulate the flow of low pH water 51 that exits the device. A high pH valve 54 is used to regulate the flow of high pH water 52 that exits the device.

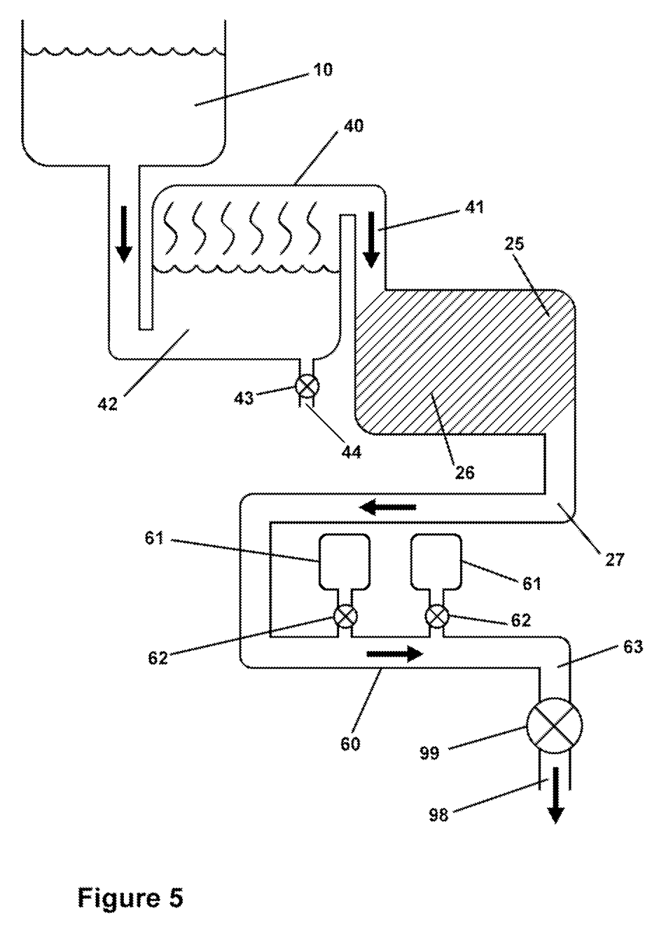

FIG. 5 is a combination of tap water, a distiller, a remineralizer, and an ionizer to create the final water product. Tap water 10 flows into a distiller 40. The water in the distiller 42 is heated, and purified water leaves the distiller 40. The distiller can have an optional valve 43 where wastewater 44 can be drained from the distiller 40. The water that exits the distiller 41 travels to a remineralizer 25. In this embodiment, the water from the reverse osmosis filter 17 travels through the remineralizer 25, which contains minerals 26. The water that exits the remineralizer 27 now contains minerals that it would not have had had the water that exits the distiller 41 not passed through the remineralizer 25. The water that exits the remineralizer 27 then travels to a holding tank, and then from the holding tank to an ionizer 30, where the ionizer 30 raises the pH of water. In this embodiment, minerals are added to water to increase the pH of the water. Minerals are stored in containers 61. Valves 62 control the flows of these minerals from the containers 61 to the water. The amount and type of minerals added to the water controls how much the pH of the water is raised or lowered. The water that leaves the ionizer 63 is the final water product 98, which exits the device through a valve 99, which regulates the flow of final water product 98 from the device.

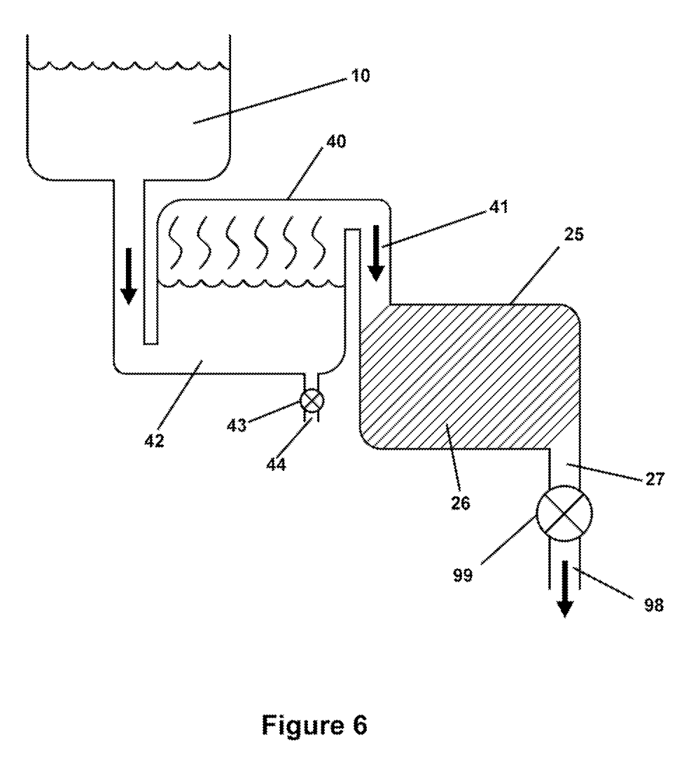

FIG. 6 is a combination of tap water, a distiller, and a remineralizer to create the final water product. Tap water 10 flows into a distiller 40. The water in the distiller 42 is heated, and purified water leaves the distiller 40. The distiller can have an optional valve 43 where wastewater 44 can be drained from the distiller 40. The water that exits the distiller 41 travels to a remineralizer 25. In this embodiment, the water from the reverse osmosis filter 17 travels through the remineralizer 25, which contains minerals 26. The water that exits the remineralizer 27 now contains minerals that it would not have had had the water that exits the distiller 41 not passed through the remineralizer 25. The water that leaves the remineralizer 27 is the final water product 98, which exits the device through a valve 99, which regulates the flow of final water product 98 from the device.

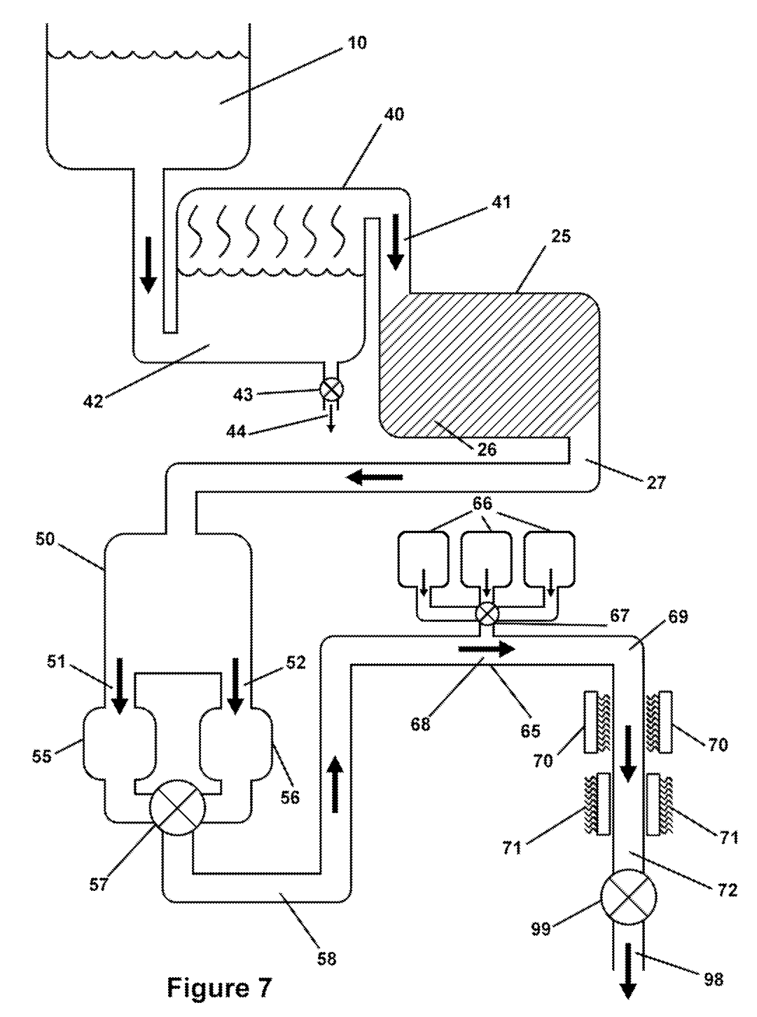

FIG. 7 is a combination of tap water, a distiller, a remineralizer, an ionizer, a flavoring system, a heater, and a cooler to create the final water product. Tap water 10 flows into a distiller 40. The water in the distiller 42 is heated, and purified water leaves the distiller 40. The distiller can have an optional valve 43 where wastewater 44 can be drained from the distiller 40. The water that exits the distiller 41 travels to a remineralizer 25. In this embodiment, the water from the reverse osmosis filter 17 travels through the remineralizer 25, which contains minerals 26. The water that exits the remineralizer 27 now contains minerals that it would not have had had the water that exits the distiller 41 not passed through the remineralizer 25. The water that exits the remineralizer 27 then travels through an ionizer 50, where the ionizer separates water into water with a low pH 51 and water with a high pH 52. This water is then stored in tanks, where the low pH water 51 is stored in tank 55 and the high pH water 52 is stored in tank 56. A valve 57 regulates the flow of water from tank 55 and tank 56, and combines them into one flow of water that exits the ionizer 58. The user, by directly or indirectly controlling the valve 57, can regulate the pH level of the water that exits the ionizer 58. The water that exits the ionizer 58 then travels to a flavoring device 65. This device contains different compartments 66 that stores flavor additives. A valve 67, or alternatively an injector, controls which flavor additives are added to the flow of water 68. A meter can be included to regulate the amount of flavoring that is added to the flow of water 68. Alternatively, the flavoring device 65 can add herbs or other supplements to the flow of water 68. The water that exits the flavoring device 69 then can pass through a heater 70 and a cooler 71. If the water needs to be heated, then the heater 70 is activated and raises the temperature of the water. If the water needs to be cooled, then the cooler 71 is activated and lowers the temperature of the water. The water that exits the cooler 72 is the final water product 98, which exits the device through a valve 99, which regulates the flow of final water product 98 from the device.

Among additional water treatment options which can be easily contained within the base unit are switches by which a user of the invention can change the pH of the water emitting from the machine. Further optional equipment could include temperature dials, which would allow a user to change the temperature of the water, separate nozzles for cold and hot water, or one nozzle that combines both and is adjustable. Solar panels can be used to partially or fully power the unit, or act as back up power. The machine can also include a monitor, where the monitor is connected to a video source, such as a DVD player, and can display promotional material to users.

In an alternative embodiment of the current invention, the holding tank that stores water after it has exited the remineralizer can be removed. Instead, a “direct flow” reverse osmosis system can be utilized whereby water from the remineralizer can flow directly into the ionizer.

A filter can also be used with the system to filter out impurities before the water goes through a reverse osmosis unit. Preferably, a carbon filter is used to remove impurities. However, additional and/or alternative means of filtering can be used. Granulated active carbon (GAC) can be used to remove chloramines. Kinetic degradation fluxion (KDF) can be used to remove heavy metals. Silica (sand) and ceramic mediums can also be used to filter the water. Activated alumna helps remove fluoride, arsenic, lead and selenium.

Chlorine and chloramines can be removed from the water using a vitamin C filter. Chlorine has long been used to treat municipal water systems. Lately, chloramines are being used more often, as they are a more stable compound. However, chloramines, containing chlorine and ammonia, are more difficult to remove from water than chlorine. A vitamin C filter can remove both chlorine and chloramines from the water. By passing water through a block of vitamin C (ascorbic acid and/or sodium ascorbate), chlorine and chloramines are converted into inorganic chlorides. One gram of vitamin C is sufficient to neutralize 1 part per million of chlorine in 100 gallons of water. Thus, a vitamin C filter can be used with the system to filter our chlorine and chloramines before the water goes through a reverse osmosis unit.

In addition to flavoring, other additives can be added to the water before it is distributed to the consumer. For example, vitamins can be added to help fortify the water. The water can be passed through herbs, teas, or other scented and/or flavored materials to impart a scent or taste to the water.

It is also possible to use the wastewater produced by the machine. Wastewater can be produced by the machine at various stages, such as from the reverse osmosis filter or the ionizer. This water can be redirected to residential or commercial gray water systems for use in applications such as landscape irrigation, toilet water, or industrial application.

Further, words with positive connotation can be located on surfaces that contain water to increase the positive effects of the water. Many in the alternative health field believe that when words with positive connotations are placed on water, the vibration of the water changes. For example, some theorize that if the word “war” is placed on a glass of water and then frozen, the water will freeze into ice with ice crystals that are non-symmetrical and fractured. If, however, the word “love” is placed on a glass of water and then frozen, the water will freeze into ice with ice crystals that are symmetrical and balanced. Positive vibrations are believed by some to increase the body's ability to successfully absorb water. Therefore, water treated with positive words can substantially improve the body's ability to become quickly and efficiently hydrated. This can benefit many individuals, such as athletes who require large amounts of water to stay hydrated. Activities and areas where water is a limited resource, such as backpacking, boating, and space travel, can benefit from water with positive vibrations; less water is required to maintain an adequate hydration of the body. In fact, airlines can benefit from this system because less water is required on each flight thereby reducing the overall weight of the aircraft and the fuel needed to propel the aircraft. Words with positive connotations include, but are not limited to: love, happy, fun, positive, smile, good, great, peace, and sweet. Additionally, positive and/or healing music can be played into the water, having a similarly positive affect to that of placing words with positive connotation around the water.

After the water has been treated, it is possible to modify the temperature of the water to meet the needs of the consumer. The water can be passed through a heater to raise the temperature of the water. Alternatively, the water can be cooled before it leaves the system. For example, the system can include a cold-water bath that is kept at a cool temperature. Then, purified water, ready to be distributed to the consumer, passes through the cold-water bath inside of a pipe. The pipe allows heat to transfer from the purified water to the cold-water bath thereby reducing the temperature of the purified water. Various knobs, buttons, or other means of interaction known in the art are capable of being used to allow the consumer to interact with the system to change the temperature of the dispensed water.

The system of the current invention can also present video and/or audio to the consumer before, during, or after water is dispensed. Promotional material can be presented to the consumer. Alternatively, positive video and/or audio can be presented to the consumer to provide an additional means of improving the mind and body of the consumer.

A particularly preferred method of treating the water in the water dispensing vending machine includes passing the water through a carbon filter to remove several impurities. Then the water travels through a reverse osmosis device to further purify the water. After passing through the reverse osmosis device, minerals must be added to the water. The added minerals enable the water to be ionized. Therefore, water must pass through a means for mineralizing water, such as a remineralizer. After the water is mineralized, the water is ionized. The water is then prepared to be dispensed to the user. However, it is also possible to further modify the water after it has been ionized. The water can be passed through UV light. Vitamins, flavoring, scents, and other additives can be added to the water.

What I claim is:

1. A device for purifying and dispensing water, comprising: a source of water, a reverse osmosis unit, a means for mineralizing water, an ionizer, and a means for dispensing water to a consumer,
where the reverse osmosis unit, the means for mineralizing water, and the ionizing unit are coupled to one another in a series connection plan, where the reverse osmosis unit is coupled to the source of water and the other units are coupled, in series configuration, such that water from the source of water passes through the reverse osmosis unit, then to the means for mineralizing the water, and then through the ionizer thereby producing treated water, where the treated water then goes to the means for dispensing water to a consumer.

2. The device of claim 1, additionally comprising an ultraviolet unit, where the ultraviolet unit is placed in series after the reverse osmosis unit and before the means for dispensing water to a consumer.

3. The device of claim 1, additionally comprising a distillation unit, where the distillation unit is placed in series before the means for mineralizing water.

4. The device of claim 1, additionally comprising a filter, where the water travels through the filter before it travels through the reverse osmosis unit.

5. The device of claim 4, where the filter is a carbon filter.

6. The device of claim 5, where the filter is a kinetic degradation fluxion filter.

7. The device of claim 1, additionally comprising a means of adding vitamins to the water.

8. The device of claim 1, additionally comprising a source of flavoring.

9. The device of claim 8, where the source of flavoring comprises one or more containers of concentrated flavoring, one or more tubes through which the flavoring can be injected into the water, and a metering device which determines how much of each of the one or more containers of concentrated flavorings is injected into the water at any one period of time.

10. The device of claim 1, further comprising a means to present audio and video to a consumer while the unit dispenses water.

11. The device of claim 1, additionally comprising a means to adjust the temperature of the water dispensed to the consumer.

12. The device of claim 1, additionally comprising a means for securing a container which can be filled with water such that the container can be filled with water emitted from the device or fed directly from a water source.

13. The device of claim 1, additionally comprising a vitamin C filter.

14. The device of claim 1, additionally comprising a container with words of positive connotation, where the water passes through the container with words of positive connotation, where the container with words of positive connotation is placed in series before the means of dispensing water to a consumer.

15. The device of claim 1, additionally comprising a means to play positive or healing music into the water before the water is dispensed to the consumer.

16. The device of claim 1, additionally comprising a means to redirect wastewater not suitable for human consumption from the machine to residential or commercial wastewater use systems.

17. A device for purifying and dispensing water, comprising: a source of water, a reverse osmosis unit, a means for mineralizing water, an ionizer, and a means for dispensing water to a consumer,
where the reverse osmosis unit, the means for mineralizing water, and the ionizing unit are coupled to one another in a series connection plan, where the reverse osmosis unit is coupled to the source of water and the other units are coupled, in series configuration, such that water from the source of water passes through the reverse osmosis unit, then to the means for mineralizing the water, and then through the ionizer thereby producing treated water, where the treated water then goes to the means for dispensing water to a consumer,
where the device further comprises one or more layers of metallic foil that is placed around the ionizer, and
where the device further comprises one or more words with positive connotations located on one or more surfaces that contain water in the device.

18. The device of claim 17, additionally comprising a carbon filter and an ultraviolet unit.

19. A method for purifying water, comprising the steps of, in order:
(1) passing water through a filter,
(2) passing the water from the filter through a reverse osmosis device,
(3) mineralizing the water from the reverse osmosis device,
(4) ionizing the mineralized water, and
(5) dispensing the water to a consumer.

20. The method of claim 19, where after step (4) and before step (5), the method further comprises the steps of, in no particular order:
(a) adding vitamins to the water,
(b) passing the water through a device that emits UV light, and
(c) passing the water through a container, where there are words of positive connotation printed on the container.
